(19) United States
(12) Patent Application Publication
(10) Pub. No.: US 2002/0135108 A1
(43) Pub. Date: Sep. 26, 2002

(54) Polycrystalline watch jewels and method of fabrication thereof

(76) Inventors: Romain L. Billiet, Penang (MY); Hanh T. Nguyen, Penang (MY)

Correspondence Address: ROM L. BILLIET, 135A MALACCA STREET, PENANG, 10400, MY

(21) Appl. No.: 10/101,027

(22) Filed: Mar. 11, 2002

Related U.S. Application Data
(60) Provisional application No. 60/281,500, filed on Mar. 31, 2001.
(60) Provisional application No. 60/279,075, filed on Mar. 23, 2001.

(51) Int. Cl. C04B 35/632; C04B 35/634

(52) U.S. Cl. 264/669; 264/670

(57) ABSTRACT

A method to produce polycrystalline sapphire or ruby watch jewels is disclosed. Green watch jewels are formed from a mixture of fine ceramic powders with a thermoplastic binder. Following extraction of the binder the parts are sintered to net shape and full density. The method obviates the inefficient and labor intensive technique of monocrystalline watch jewel manufacturing. The purity of the raw materials and processing conditions result in sintered polycrystalline rubies or sapphires with homogeneous microstructures, small grain size and hardness similar to that of their synthetic monocrystalline counterparts.

U.S. Pat. No. 3,622,739 November 1971 Steffen 219/121.7 U.S. Pat. No. 3,962,558 June 1976 Kocher et al. 219/121.71 U.S. Pat. No. 4,028,967 June 1977 Fried 81/7

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND-FIELD OF INVENTION

The present invention relates to watch jewels.

### BACKGROUND-DESCRIPTION OF PRIOR ART

The terms watch jewels, watch rubies, or simply jewels or rubies, are generally indiscriminately applied to natural or synthetic sapphires or rubies used as bearings in timepieces in order to minimize friction and wear of moving mechanical parts, e.g. the gear trains, the balance and the escapement.

Watch jewels are indispensable to the long life and correct functioning of watches and are, therefore, a decisive contributor to the quality of a watch.

In simple hand-wound mechanical watches, i.e. watches having only hours, minutes and seconds hands, the number of jewels varies from a minimum of 14 to a maximum of 19. Automatic or complicated watches, having more moving parts, require more rubies.

In the early days of watch making, the axle pivots of moving parts turned directly in holes drilled into two brass plates separated by spacers. To facilitate assembly and repair, the upper plate was later replaced by separate elements, called bars, bridges or cocks, depending on the number of spacers used. The holes in the bottom plate also contained small oil wells to lubricate the pivots. Over time, dust mixed with oil formed an abrasive substance which ovalized the holes and eroded the steel pivots, eventually causing the watch to work erratically or stop functioning altogether.

This led watchmakers to turn to hard precious stones as the material from which to make pivot bearings. Initially, 18^{th} century watchmakers used small sapphire or ruby pellets, rejects from the jewelry trade, hence the name jewels. The most common natural stone used for watch jewels was sapphire as ruby lacked the uniform hardness of sapphire.

The traditional method of making watch jewels, still practiced by artisan watchmakers making custom-made timepieces, consists of fashioning the stones individually, using simple hand tools and the lapidary lathe. The process involves following steps:

1. Mounting a blank stone onto a base plate and grinding one side of the stone flat.

2. Reversing the position of the stone so that the ground face is now fixed onto the base plate and grinding the other side flat until the desired thickness has been achieved.

3. Securing the flat blank to the end of a cylindrical brass rod with diameter slightly larger than that of the finished ruby and, using this rod as a handle, grinding the stone to an approximately round shape substantially flush with the brass rod.

4. Fixing the rounded blank to the hollowed out end of a cylindrical brass rod with diameter just smaller than of the finished bearing and mounting said rod with blank onto the lapidary lathe.

5. Using a diamond tool, making a chamfer in the center of the blank stone.

6. Next, using a diamond paste-coated hardened steel punch, applying pressure onto the rotating stone, in successive tapping motions, until the stone is pierced. During this operation the punch has to be changed or rehardened several times.

7. Using the appropriate tools, grinding and polishing the oil well, the dome and the hole filet.

8. Honing the inner side of the borehole.

9. Trueing the outer diameter of the jewel.

10. Reversing the position of the stone and chamfering the bottom edge of the outer diameter.

For two centuries, this fastidious, wasteful and labor-intensive procedure limited the use of jewels to but the most exclusive and expensive watches.

A first breakthrough in watch jewel manufacturing came in 1902 with the development by Auguste Verneuil, professor at the Paris Conservatoire des Arts et Metiers, of a process to make synthetic gemstone. This allowed large-scale manufacture of synthetic precious stones, more homogeneous in quality than the ones found in nature. Today the jewelry trade takes the lion's share of all synthetic gemstone produced by the Verneuil process and virtually all watch jewels today are made from synthetic sapphire or ruby made by this process.

The Verneuil process starts by fusing pure alumina or chromium-doped alumina-depending on the desired end product —to generate a so-called ‘boule’, a ball of fused ceramic used to initiate the single crystal growing process. For watch jewel manufacturing the single crystal is grown to the size of a pear measuring about 2 inches in diameter at the thickest section and about 6 inches in length. After slow cooling the sapphire or ruby monocrystal is diamond-sawed axially into two halves which are glued, sawed face down and head to tail next to each other, onto a wooden block. The two halves are then jointly diamond-sawed into slices of 0.3-0.5 mm thickness. Each half moon shaped slice thus obtained is subsequently sawed into squares which are individually ground into rounds of about 1.15-2.55 mm in diameter. Next the holes are drilled into the rubies and the remaining design features produced by individual grinding and polishing. To polish the outer dome, several hundred rubies are glued onto a plate and 4-6 such loaded plates are brush-polished in bulk. Finally, the rubies are strung by the hundreds onto a tungsten wire coated with diamond fluid and jigged back and forth in order to rectify and polish the inner bore. In the entire process a mere 10% of the original ruby crystal is actually converted into finished watch jewels. The remaining 90% is lost.

A farther breakthrough in watch jewel manufacturing came in the early 1970s with the use of pulsed laser beams to drill the holes. However laser beams are only marginally effective in drilling holes in sapphires or rubies as most of the energy of the incident laser beam is transmitted instead of being absorbed, the coefficient of absorption of transparent materials being by definition very low.

Hence careful adjustment of the frequency and intensity of the pulsed laser beam is critical. Clearly, if the average intensity of the pulses is too low, the energy required to perform the drilling operation will be insufficient. On the other hand, if the maximum intensity of the peaks is too high, say above 10⁹W/cm², shock waves or non-linear optical effects may result. Also, if a spike having a very high intensity reaches the workpiece, a large quantity of material is suddenly vaporized or melted, whereby droplets or even small particles of solid material are ejected. As a result of the very fast heating rate small bulges and cracks may develop at or in the vicinity of the area impacted by the laser beam.

Kocher et al., U.S. Pat. No. 3,962,558 attempt to overcome these problems by increasing the intensity of the first spike so as to vaporize only a thin surface layer of the workpiece material and providing succeeding spikes with just sufficient energy such that each vaporizes a layer of material having a thickness of approximately 20 μm.

As a rule, all laser-drilled holes in watch jewels are non-uniform and must still be rectified and polished by the traditional method.

In spite of the low yield and above problems of the prior art, synthetic watch jewels can now be obtained in a wide range of standardized sizes and made to very precise dimensional tolerances. Holes are concentric with the outer edge and are internally polished to a tolerance of 0.005 mm for smaller holes and 0.01 mm for larger ones.

### BRIEF SUMMARY OF THE INVENTION

In accordance with the present invention the labor-intensive and inefficient techniques of the prior art are substantially overcome by injection molding polycrystalline watch jewels to net, i.e. final shape. The purity of the raw materials and the processing conditions used result in sintered jewels having a homogeneous microstructure with extremely small grain size while hardness is substantially similar to that of synthetic monocrystalline stones. Furthermore, design freedom and dimensional accuracy are greatly improved through the application of this invention.

### OBJECTS AND ADVANTAGES

It is the primary object of this invention to provide an economic, simple, energy and material efficient process to mass-produce polycrystalline watch jewels with improved dimensional accuracy.

An additional object of this invention is to provide a method to fabricate polycrystalline watch jewels that are smaller in size than those achievable by the prior art.

### BRIEF DESCRIPTION OF THE SEVERAL VIEWS OF THE DRAWINGS

FIG. 1 is a cross-section of a typical watch jewel, showing the top (10) and bottom (11) surfaces, the outer edge (12), the hole (13), the oil well (14), the dome (15), the oil well filet (16) and the outer edge chamfer (17).

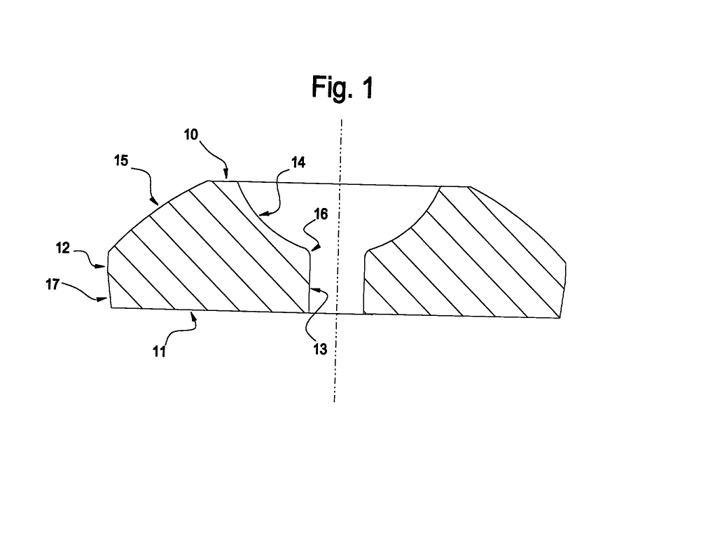

### DETAILED DESCRIPTION OF THE INVENTION

Briefly, this invention starts by compounding a homogeneous thermoplastic mixture, also called green mixture, green compound or feedstock, consisting of a discrete phase made up of fine particulate ceramic material, and an organic continuous phase, generally termed the organic binder or simply the binder.

The discrete phase of the thermoplastic compound contains at least one finely divided particulate ceramic material, such as ultrapure alumina powder if the desired end material is polycrystalline sapphire, or alumina powder doped with 1-4% chromium oxide if the desired end material is polycrystalline ruby.

The continuous phase of the thermoplastic compound is made up of at least one thermoplastic organic material though generally it will be made up of different organic constituents which may include polyolefin resins, silicones, waxes, oils, greases and the like. In most cases various organic surface active materials (surfactants), plasticizers and antioxidants will also be included to optimize the characteristics of the particulate materials and to avoid or retard premature oxidative degradation of the organic binder.

Usually the binder will be specifically formulated in order to optimize the thermoplastic compound's properties, such as its rheological behavior, as well as the solidification-, glass transition-, flow- and melting temperatures and thermal decomposition pattern of the organic binder.

The number of combinations and permutations possible at this point are very great and anyone skilled in the art will be well aware of the number of possibilities that exist to them to obtain the desired characteristics of the binder. Enumerating such possibilities would not materially contribute to the description of this invention. However, a typical formula for the organic binder mixture would be approximately one-third by weight of polyethylene, one-third by weight of paraffin wax, one-third by weight of beeswax with perhaps 0.1-0.2 percent of stearic acid and 0.05% of an antioxidant added.

The discrete particulate materials and thermoplastic binder ingredients are mixed together into a homogeneous mass at a temperature in excess of the melting point or flow point of the thermoplastic materials. Techniques for producing thermoplastic compounds are well described in the prior art and will not be elaborated on here.

The thermoplastic or green compound is formulated in such way that it is a solid at or below 25° C. This way it can be easily worked or shaped by well-known techniques such as machining, casting, molding, extruding and the like.

The organic binder is formulated in such way as to be extractable from the thermoplastic or green compound using well-known techniques such as aqueous or organic solvent extraction, oxidative degradation, catalytic decomposition, vacuum distillation, wicking and the like, leaving behind a framework that is substantially devoid of organic material and consisting only of the particulates of the discrete phase, coherently held together by the weak interatomic Van der Waals forces at the points of contact between contiguous particles of the discrete phase.

This binder-free structure can now be sintered to its final dense end configuration in accordance with prior art techniques. Fine-grained polycrystalline sapphire or ruby jewels can be achieved if sintering is conducted in an oxidizing atmosphere while translucency can be achieved if sintering is performed in pure hydrogen.

A preferred embodiment is constituted by applying this invention in conjunction with the methods described in these inventors' patent application Ser. No. 09/962,526 entitled: Method For Controlling The Dimensions Of Bodies Made From Sinterable Materials and their Provisional Patent Application Ser. No. 60/279,075 entitled: Porous Nanostructures and Method Of Fabrication Thereof.

In this manner watch jewels of ultraprecise dimensional accuracy and dimensionally much smaller than what the prior art is able to achieve can be produced.

### EXAMPLE I

3,207 g of spray dried alumina powder grade BAX54 from Baikowski Chimie, Annecy, France, with an average particle size of 0.4 microns and a nominal surface area of 6-9 m²/g, blended with 6.736 g of magnesium dioxide grade L365 of Merck AG, Darmstadt, Germany was desorbed under high vacuum conditions. A measured quantity of 0.179 g of phospatidylcholine was allowed to adsorb onto the surface of the powders which were subsequently mixed with 244 g of paraffin wax and 268 g of polyethylene. The mixed compound was molded into green watch jewels having an outside diameter of 2.390 mm. Following extraction of the thermoplastic binder in accordance with prior art practice, the parts were sintered in hydrogen at 1800° C. for 15 minutes. Upon cooling the parts had the appearance and properties of polycrystalline translucent sapphire. The outer diameter of the sapphire watch jewels had shrunk to the desired dimension of 2 mm.

### EXAMPLE II

3,030 g of spray dried alumina powder grade BAX54 from Baikowski Chimie, Annecy, France, blended with 145.56 g of chromium oxide grade 2483 of Merck AG, Darmstadt, Germany was loaded in a closed circuit attriting installation. Following desorption of the attrited powder, 1.91 g of phospatidylcholine was allowed to adsorb onto the surface of the powders which were then mixed with 251.77 g of paraffin wax and 261.64 g of polyethylene. The mixed compound was molded into green watch jewels having outside diameter of 0.6 mm. Following extraction of the thermoplastic binder the green parts were sintered in a microwave oven at 600° C. for 8 minutes. After sintering the parts had a deep ruby color. The diameter of the sintered microrubies was 0.5 mm as per design.

### CONCLUSION, RAMIFICATIONS AND SCOPE

In conclusion, the major advantage of this invention resides in the ability to economically mass-produce polycrystalline sapphire and polycrystalline ruby watch jewels without machining or associated waste of materials or energy.

The tolerance capability on the diameter of the hole of watch jewels made by this invention far exceeds the prior art's 0.005 mm and, typically, is the 20-60 nm range on a hole of diameter 0.2 mm.

We claim as our invention:

1. A method for making polycrystalline watch jewels comprising the steps of:
a. mixing accurately determined volumes of at least one sinterable ceramic particulate material and at least one degradable thermoplastic material into a homogeneous thermoplastic compound,
b. shaping said thermoplastic compound into green watch jewels,
c. extracting substantially all the organic material from said green watch jewels and sintering the resulting binder-free preforms.

2. The method of claim 1 whereby said degradable thermoplastic binder ingredient or ingredients are selected from the class of polyolefins, waxes, plasticizers, greases, oils, surfactants or mixtures of these.

3. The method of claim 2 whereby said sinterable ceramic particulate materials include ceramic nanoparticulates.

4. The method of claim 3 whereby said sinterable ceramic particulate materials include aluminum oxide.

5. The method of claim 4 whereby said aluminum oxide is doped with chromium oxide.

6. The products of claim 4.

7. The products of claim 5.
